(19) United States
(12) Patent Application Publication
(10) Pub. No.: US 2025/0039925 A1
(43) Pub. Date: Jan. 30, 2025

(54) ADJUSTMENT OF CONTENTION WINDOW FOR LBT

(71) Applicant: Nokia Technologies Oy, Espoo (FI)

(72) Inventors: Nuno Manuel KIILERICH PRATAS, Aalborg (DK); Ling YU, Espoo (FI); Torsten WILDSCHEK, Gloucester (GB); Vinh VAN PHAN, Oulu (FI); Yong LIU, Shanghai (CN); Tao TAO, Shanghai (CN); Naizheng ZHENG, Beijing (CN)

(21) Appl. No.: 18/716,008

(22) PCT Filed: Dec. 14, 2021
(86) PCT No.: PCT/CN2021/137834

§ 371 Date: Jun. 3, 2024

(51) Int. Cl. H04W 74/0808; H04W 24/08

(52) U.S. Cl. CPC H04W 74/0808; H04W 24/08

(57) ABSTRACT

Example embodiments of the present disclosure relate to adjustment of contention window (CW) for listen before talk (LBT). A device determines a target size of a contention window for listen before talk at least in part based on at least one of a first metric and a second metric. The first metric indicates a level of intra-system activity of one of the plurality of systems. The second metric indicates a level of inter-system activity of the plurality of systems. The at least one of first and second metrics are determined by the device based on one or more messages in a set of resources shared by a plurality of systems. This solution enables the device to adjust the LBT by determining the target size of the contention window. By doing so, the device may determine an appropriate size of the contention window even when HARQ feedback is not available. In this way, a system may be able to coexist fairly with other systems in unlicensed spectrum.

### FIELD

Embodiments of the present disclosure generally relate to the field of telecommunication and in particular, to methods, devices, apparatus and computer readable storage medium for adjustment of contention window (CW) for listen before talk (LBT).

### BACKGROUND

With the rapid development of the communication technology, communication systems can support various types of services for terminal devices, such as transmissions between terminal devices. In recent communication technologies, it has been proposed to support SL transmissions between terminal devices. In some cases, the terminal devices are required to access resources in unlicensed spectrum by performing a LBT procedure to use the resources for SL operations. For example, an “extended” LBT (also referred to as a LBT type 1) may be applied where a channel need to be free for an entire duration of a CW. In a communication environment where a plurality of systems sharing an unlicensed spectrum, the duration or the size of the CW for the LBT need to be adjusted to reduce collisions. Works are ongoing to introduce adjustment of the CW for the LBT, to improve the SL performance in the unlicensed spectrum.

### SUMMARY

In general, example embodiments of the present disclosure provide methods, devices, apparatus and computer readable storage medium for adjustment of CW for LBT.

In a first aspect, there is provided a device. The device comprises at least one processor; and at least one memory including computer program code; where the at least one memory and the computer program code are configured to, with the at least one processor, cause the device to receive one or more messages in a set of resources shared by a plurality of systems. The device is caused to determine, based on the one or more messages, at least one of a first metric and a second metric. The first metric indicates a level of intra-system activity of one of the plurality of systems. The second metric indicates a level of inter-system activity of the plurality of systems. The device is further caused to determine, at least in part based on the at least one of the first and second metrics, a target size of a contention window for listen before talk.

In a second aspect, there is provided a device. The device comprises at least one processor; and at least one memory including computer program code; where the at least one memory and the computer program code are configured to, with the at least one processor, cause the device to determine one or more sub-channels from a plurality of sub-channels shared by a plurality of systems. One or more received signal powers of a plurality of received signal powers associated with the one or more sub-channels exceed a threshold. The device is caused to determine, based on a portion of the one or more sub-channels of the plurality of sub-channels, a third metric indicating a level of a joint intra- and inter-system activity of the plurality of systems. The device is further caused to determine, based on the third metric, a target size of a contention window for listen before talk.

In a third aspect, there is provided a method. In the method, a device receives one or more messages in a set of resources shared by a plurality of systems and determines, based on the one or more messages, at least one of a first metric and a second metric. The first metric indicates a level of intra-system activity of one of the plurality of systems. The second metric indicates a level of inter-system activity of the plurality of systems. The device further determines, at least in part based on the at least one of the first and second metrics, a target size of a contention window for listen before talk.

In a fourth aspect, there is provided a method. In the method, a device determines one or more sub-channels from a plurality of sub-channels shared by a plurality of systems. One or more received signal powers of a plurality of received signal powers associated with the one or more sub-channels exceed a threshold. The device further determines, based on a portion of the one or more sub-channels of the plurality of sub-channels, a third metric indicating a level of a joint intra-system and inter-system activity of the plurality of systems. The device further determines, based on the third metric, a target size of a contention window for listen before talk.

In a fifth aspect, there is provided an apparatus. The apparatus comprises means for performing the method according to the third aspect or the fourth aspect.

In a sixth aspect, there is provided a computer readable medium. The computer readable medium comprises program instructions for causing an apparatus to perform at least the method according to the third aspect or the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates example architecture of a channel access procedure with a LBT for SL transmission;

FIG. 3 illustrates a flowchart of a method implemented at a device according to some example embodiments of the present disclosure;

FIG. 4 illustrates a flowchart of a method for determining a size of a contention window according to some example embodiments of the present disclosure;

FIG. 5 illustrates a flowchart of a method for determining the size of the contention window based on at least one of first and second metrics according to some example embodiments of the present disclosure;

FIG. 6 illustrates another flowchart of a method for determining the size of the contention window based on at least one of first and second metrics according to some example embodiments of the present disclosure;

FIG. 7 illustrates another flowchart of a method implemented at a device according to some example embodiments of the present disclosure;

FIG. 8 illustrates a flowchart of a method for determining whether to determine the target size of the CW according to some example embodiments of the present disclosure;

FIG. 9 illustrates a simplified block diagram of an apparatus that is suitable for implementing example embodiments of the present disclosure; and

FIG. 10 illustrates a block diagram of an example computer readable medium in accordance with some example embodiments of the present disclosure.

Throughout the drawings, the same or similar reference numerals represent the same or similar element. Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first.” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, a resource in both frequency domain and time domain will be used as an example of a transmission resource for describing some example embodiments of the present disclosure. It is noted that example embodiments of the present disclosure are equally applicable to other resources in other domains.

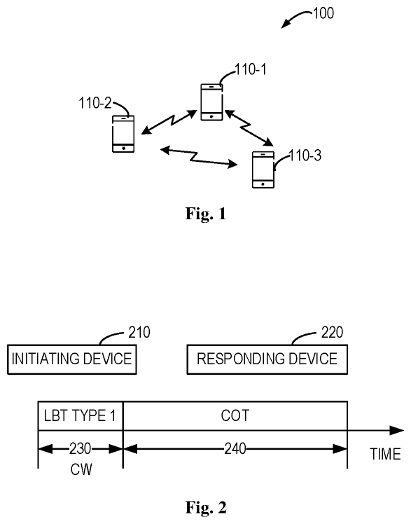

Principle and implementations of the present disclosure will be described in detail below with reference to FIGS. 1-10.

### Example Communication Environment

FIG. 1 shows an example communication environment 100 in which embodiments of the present disclosure can be implemented.

The communication environment 100 includes three devices 110-1, 110-2 and 110-3. For ease of discussion, the devices 110-1, 110-2, and 110-3 may be collectively referred to as “devices 110” or individually referred to as a “device 110”. In the example of FIG. 1, the devices 110 are illustrated as terminal devices. The communication environment 100 may include an additional network device. It is to be understood that the device 110 may also be implemented by a network device. For the purpose of discussion, some example embodiments of the present disclosure will be discussed by taking terminal devices as an example of the devices 110.

It is to be understood that the number of devices and their connections as shown in FIG. 1 is only for the purpose of illustration without suggesting any limitations. The communication environment 100 may include any suitable number of devices adapted for implementing embodiments of the present disclosure.

In the communication environment 100, the devices 110 can communicate data and control information with each other. Links between the devices 110 may be referred to as a SL. The device 110 performing a transmission is referred to as a transmitting (TX) device (or a transmitter), and the device 110 receiving the transmission is referred to as a receiving (RX) device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

SL communications may support one or more types of communications including unicast communications, multicast communications, and broadcast communications. SL communications may be performed in one or more channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

In some example embodiments, the communication environment 100 may comprise a plurality of systems. For example, a new radio (NR) system, an IEEE 802.11 system and other suitable systems. The NR system may operate in the unlicensed bands for example at sub-7 GHz unlicensed bands (for example, the unlicensed bands below 7 GHZ, including the 2.4, 3.5, 5 and 6 Ghz bands). Other systems such as the IEEE 802.11 system may also operate at the sub-7 GHZ unlicensed bands. For example, a WiFi (IEEE 802.11a/n/ac/ax) system may operate in the 5 GHz bands. That is, the NR system may be coexistence with other systems in the communication environment 100.

In some example embodiments, the device 110 may use the NR system and/or the other systems such as the WiFi system. For example, the device 110-1 may use the NR system while the device 110-2 may use the WiFi system. It is to be understood that the device 110 may use a different system at a different time. For example, the device 110-1 may use the NR system during a first time period, and switch to use the WiFi system during a second time period.

In some example embodiments, SL resource allocation may be performed for the device 110 using the NR system (referred to as resource allocation mode 1 hereinafter). When the device 110 is in RRC connected state, the device 110 may get resources by using the resource allocation mode 1. For example, when the device 110 needs to transmit data via SL, the device 110 may report information about the SL transmission, such as the Buffer Status Report (BSR), to a network device. Then the network device may allocate resources for the SL transmission to the device 110.

In some example embodiments, the device 110 may perform autonomously resource selection with the aid of a sensing procedure (referred to as resource allocation mode 2 hereinafter). For example, the device 110-1 may determine, based on information obtained from full sensing or partial sensing (for example, sidelink control information (SCI) via PSFCH), whether the resource on the SL is preempted by another device 110-2 in the communication environment 100. Then, the device 110-1 may choose an unoccupied resource for the SL transmission. The mode 2 resource allocation may be used in coverage (IC) or out of coverage (OoC); in RRC connected, RRC idle or RRC inactive without the need of coordination on resource allocation from the network device.

### Example Channel Access Procedure with LBT

In a communication environment with a plurality of systems, to operate over a shared frequency band such as an unlicensed band, different channel access procedures comprising listen before talk (LBT) may be used before performing a transmission by the device 110. For example, to pass the LBT, a device need to observe the shared frequency band as available for a number of consecutive clear channel assessment (CCA) slots. In sub-7 GHz bands, the duration of a slot is 9 μs. For example, if a measured power (i.e., a collected energy during the CCA slot) is below a predetermined threshold, then the device may determine that the shared frequency band as available in this CCA slot. The predetermined threshold may be determined based on the operating frequency band and geographic region.

FIG. 2 illustrates example architecture 200 of a channel access procedure with a LBT for SL transmission.

In the example of FIG. 2, an initiating device 210 intends to perform a transmission to a responding device 220 using resources on a shared frequency band. The initiating device 210 and the responding device 220 may be two of the devices 110 in FIG. 1. As used herein, the term “initiating device” may refer to a device that initiates a transmission to one or more other devices. As used herein, the term “responding device” may refer to a device to which the initiating device performs the transmission.

In such examples, the initiating device 210 needs to perform a channel access procedure to get access to the resources on the shared frequency band for the transmission. For example, the initiating device 210 needs to acquire the permission to access the shared frequency band for a certain period of time, which is also referred to as the Channel Occupancy Time (COT) 240 by applying a LBT procedure.

In some example embodiments, the LBT may be an “extended” LBT procedure (for example, a LBT Type 1 procedure) where the shared frequency band is determined as free for the duration of a Contention Window (CW) 230. After the initiating device 210 successfully completes the LBT Type 1 check after the duration of CW 230, the initiating device 210 may perform a transmission during the COT 240.

As discussed above, the communication environment may comprise a plurality of systems such as a NR system and a WiFi system. Conventionally, to reduce collisions between the systems, various mechanisms can be applied. For example, intra-system collisions between the devices using the NR system (also referred to as NR devices) may be avoided by controlling these NR devices by a network device in the NR system. For another example, intra-system collisions between the devices using the WiFi system (also referred to as WiFi devices or WiFi nodes) may be avoided by a distributed load condition mechanism. However, there may be inter-system collisions in the shared unlicensed band between the NR system and other systems such the WiFi system.

To reduce the inter-system collisions between the NR system and other systems, a CW adjustment mechanism based on hybrid automatic repeat request (HARQ) feedback has been proposed in the NR system. An initiating device may determine to increase or reset a size of the CW (also referred to as contention window size, or CWS) based on detection of HARQ acknowledgement (ACK) or HARQ non-acknowledgement (NACK) received from a responding device. For example, in NR SL unicast and groupcast, HARQ feedback may be configured for SL retransmission. The initiating device may be aware of the reception status of the responding device to determine the need of retransmission or not. In addition, NL SL also supports blind retransmission without need of HARQ feedback. The initiating device may indicate the need of HARQ feedback in the second stage of SL control information (SCI).

However, there are cases where the HARQ feedback is absent, such as in broadcast, unicast without HARQ or groupcast without HARQ, or where decoding errors are expected to be recovered via blind retransmissions. In such cases, the CW adjustment cannot be performed without the HARQ feedback. For example, the NR device cannot determine when to adjust the CWS without the HARQ feedback. Without the CW adjustment, it cannot ensure that the NR device is still able to coexist with other devices using the other systems. That is, inter-system collisions will occur without the CW adjustment between the NR device and the other devices, which will impact on the SL transmissions on the shared frequency band.

It has been proposed to reuse a latest size of the CW obtained from other HARQ acknowledged transmissions or to use a minimum size of the CW in the absence of transmissions with HARQ feedback. However, as there is usually more than one transmission without HARQ feedback, such approach is not friendly towards other systems, and may lead to potential collisions.

As discussed above, it is challenging to enhance SL transmissions on a shared frequency band. According to some example embodiments of the present disclosure, there is provided a scheme for CW adjustment. In this scheme, a device determines a level of intra-system activity of one of a plurality of systems and a level of inter-system activity of the plurality of systems based on one or more messages received in a set of shared resources. The device determines a target size of a contention window for LBT at least in part based on the level of intra-system activity and the level of inter-system activity. This scheme enables the device to adjust the size of the contention window based on the level of intra-system activity and/or the level of inter-system activity. Particularly, adjusting the size of the contention window for LBT based on intra-system and inter-system activity levels will enable the device to select an appropriate size of the contention window even in the situation that no HARQ feedback is available. In this way, the devices or the NR system will be able to coexist fairly with other systems in unlicensed spectrum by performing such CW adjustment. In addition, transmissions such as SL transmissions in unlicensed band (SL-U) performance will be enhanced.

### Example Transmission with CW Adjustment

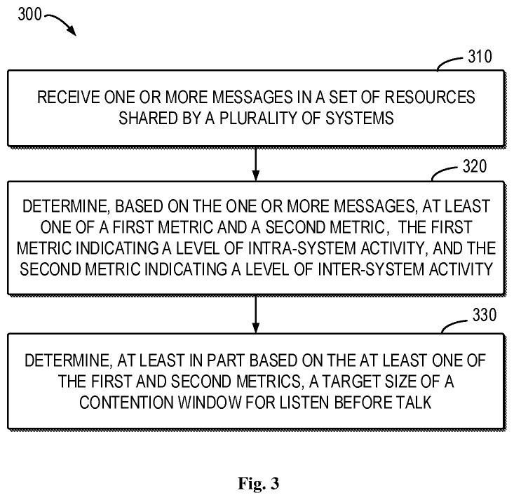

FIG. 3 illustrates a flowchart of a method 300 implemented at a device according to some example embodiments of the present disclosure. For the purpose of discussion, the method 300 will be described from the perspective of a device 110 in FIG. 1.

At block 310, the device 110 receives one or more messages in a set of resources shared by a plurality of systems. In some example embodiments, the one or more messages may comprise a plurality of SCI messages. The plurality of SCI messages may contain a plurality of received signal reference powers (RSRPs) associated with the plurality of sub-channels.

At block 320, the device 110 determines, based on the one or more messages, at least one of a first metric and a second metric. The first metric indicates a level of intra-system activity of one of the plurality of systems. The second metric indicates a level of inter-system activity of the plurality of systems. The term of “level of the intra-system activity” may refer to a level of signal powers in a shared frequency band where the signal powers are occurred in a given system such as a NR system. The term of “level of the inter-system activity” may refer to a level of signal powers in the shared frequency band where the signal powers are associated with other systems sharing the shared frequency band with the given system.

In some example embodiments, the device 110 may determine the first metric based on the plurality of RSRPs. For example, the device 110 may determine one or more sub-channels from the plurality of sub-channels. One or more RSRPs of the plurality of RSRPs associated with the one or more sub-channels exceed a threshold power. The device 110 may determine the first metric based on a portion of the one or more sub-channels of the plurality of sub-channels. In other words, the first metric in a given slot represents the portion of sub-channels in the set of resources whose SL RSRP associated with the received SCI messages in the given slot measured by the device 110 exceed a threshold power sensed over a measurement window. As used herein, the term of “first metric” can also be referred to as “an intra-system CBR”.

In some example embodiments, the device 110 may further detect a plurality of received signal powers associated with the plurality of sub-channels. For example, the device 110 may detect a plurality of (SL) reference signal strength indicator (RSSI) during the observation period. The SL RSSI may be defined as a linear average of the total received power observed in a sub-channel in orthogonal frequency-division multiplexing (OFDM) symbols of a slot configured for PSCCH and PSSCH, starting from the second OFDM symbol.

In some example embodiments, the device 110 may determine the second metric based on the plurality of received signal powers and the plurality of RSRPs. For example, the device 110 may determine one or more sub-channels from the plurality of sub-channels. A difference between one or more RSRPs of the plurality of RSRPs and one or more RSSI of the plurality of RSSIs associated with the one or more sub-channels exceeds a threshold difference. The device 110 may determine the second metric based on a portion of the one or more sub-channels of the plurality of sub-channels. That is, the second metric in a given slot represents the portion of sub-channels in the set of resources whose SL RSSI minus the SL RSRP associated with the received SCIs in the given slot measured by the device 110 exceed a threshold sensed over a measurement window [n-a, n-1], wherein a is equal to 100 or 200 us slots, according to higher layer parameter sl-Time WindowSizeCBR. As used herein, the term of “second metric” can also be referred to as “an inter-system CBR”.

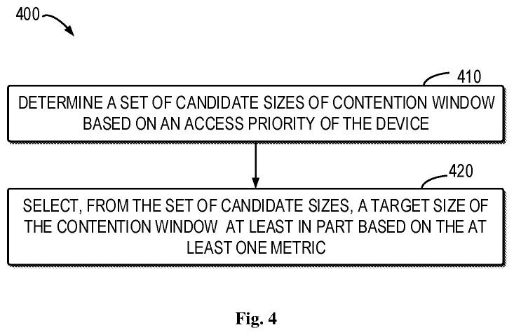

At block 330, the device determines, at least in part based on the at least one of the first and second metrics, a target size of a CW for LBT. For example, if the device 110 determines that the first metric is below a first threshold, the device 110 may determine a target size of the CW based on the second metric. In another example, if the device 110 determines that the first metric exceeds the first threshold, the device 110 may determine a minimum size in a set of candidate sizes to be the target size of the CW. Details regarding how to determine the target size of the CW will be described with respect to FIGS. 4-6.

By using the method 300 described above, the device 110 can determine the target size for the LBT without receiving HARQ feedback. In this way, even in the situation where no HARQ feedback is configured, the device 110 may also adjust the size of the CW for the LBT, which will in turn reduce collisions between different systems. In this way, the SL transmission performance will be enhanced.

### Example CW Size Determination

Example embodiments regarding CW adjustment have been described above. Several example embodiments regarding how to determine the size of the CW without the HARQ feedback will be described with respect to FIGS. 4-6 below.

FIG. 4 illustrates a flowchart of a method 400 for determining a size of a contention window according to some example embodiments of the present disclosure. FIG. 4 can be regarded as an example implementation of the block 330 in FIG. 3. For the purpose of discussion, the method 400 will be described from the perspective of a device 110 in FIG. 1.

At block 410, the device 110 may determine a set of candidate sizes of CW based on an access priority of the device 110. For example, the device 110 may determine the set of candidate sizes based on the CAPC of the device 110. For example, Table 1 shows several example sizes of CW.

TABLE 1
Example sizes of CW

| Channel | | | | |
|---|---|---|---|---|
| Access | | | | |
| Priority | | | | |
| Class (p) | CW_{min, p} | CW_{max, p} | T_{ulm cot, p} | allowed CWₚ sizes |
| 1 | 3 | 7 | 2 ms | {3, 7} |
| 2 | 7 | 15 | 4 ms | {7, 15} |
| 3 | 15 | 1023 | 6 ms or | {15, 31, 63, 127, 255, |
| | | | 10 ms | 511, 1023} |
| 4 | 15 | 1023 | 6 ms or | {15, 31, 63, 127, 255, |
| | | | 10 ms | 511, 1023} |

In Table 1, CW_{min, p} and CW_{max, p} respectively denote the minimum and maximum CW size in CCA slots associated with each CAPC; T_{ulm cot, p} denotes the duration of the COT; p denotes channel access priority class (CAPC). Control plane traffic such as PSCCH is transmitted with p=1, while user plane traffic has p>1. For example, when the duration of COT is equal to 6 ms, it may be increased to 8 ms by inserting one or more guard periods.

At block 420, the device 110 may select, from the set of candidate sizes, a target size of the CW at least in part based on the at least one of the first and second metrics. For example, in some example embodiments, if the device 110 determines that the first metric is higher than a first threshold, the device 110 may select a minimum size in the set of candidate sizes as the target size.

In some example embodiments, the set of candidate sizes comprise a plurality of candidate sizes with a plurality of index values ranked in an ascending order of the associated candidate sizes. For example, in Table 1, when the CAPA is equal to 1, the set of candidate sizes comprise {3, 7}. In this example, the size of “3” may be associated with a rank 0 and the size of “7” may be associated with a rank 1. Likewise, when the CAPC is equal to 3, the set of candidate sizes comprise {15, 31, 63, 127, 255, 511, 1023}. In this example, the size of “15” is associated with a rank 0, the size of “31” is associated with a rank 1 . . . , and the size of “1023” is associated with a rank 6. Alternatively, in some example embodiments, the set of candidate sizes may also comprise a plurality of candidate sizes with a plurality of index values ranked in a descending order of the associated candidate sizes.

In the examples where the device 110 may select the minimum size in the set of candidate sizes as the target size, the device 110 may determine the target index values to be equal to 0. The target size of “3” in the example where the CAPC is equal to 1, and the target size of “15” where the CAPC is equal to 3 may be selected based on the target index value.

Taking the target size equal to 15 as an example, an actual size of the CW used by the device 110 may be equal to =floor (u*target size), where u is a uniform random variable between 0 and 1 (i.e., u˜Uni (0,1)). For example, if u=0.1, then the actual size of the CW used would be floor (0.1*15)=1 CCA slots, where a CCA slot is 9 μs. It is to be understood that the example index value, the example value of the CAPC, and the example set of candidate sizes are only for the purpose of illustration without suggesting any limitations.

By determining the target size of the CW based on the at least one metric, the device may adjust the size of the contention window without receiving the HARQ feedback. In this way, the devices or the NR system will be able to coexist fairly with other systems in unlicensed spectrum by performing such CW adjustment. In addition, SL in unlicensed band (SL-U) performance will be enhanced.

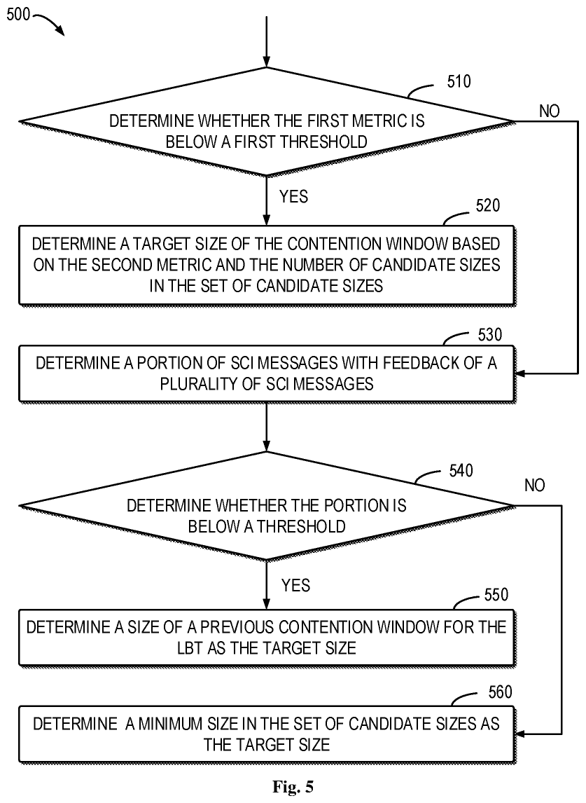

FIG. 5 illustrates a flowchart of a method 500 for selecting the size of the contention window from the candidate sizes according to some example embodiments of the present disclosure. FIG. 5 can be regarded as an example implementation of the block 420 in FIG. 4. For the purpose of discussion, the method 500 will be described from the perspective of a device 110 in FIG. 1.

At block 510, the device 110 may determine whether the first metric is below a first threshold. For example, the first threshold may be a preconfigured level of activity. The first threshold may be a value between 0 and 1. If it is determined that the first metric is below the first threshold at block 510, then the method 500 may proceed with block 520.

At block 520, the device 110 may determine the target size of the CW based on the second metric and the number of candidate sizes in the set of candidate sizes. For example, as discussed above, the set of candidate sizes may comprise a plurality of candidate sizes with a plurality of index values ranked in an ascending order of the associated candidate sizes. The device 110 may determine a target index value based on the second metric and the number of candidate sizes in the set of candidate sizes. Example calculation for the target index value may be described as below:

$${CWS}_{rel , index} = ⌊ {CBR}_{interS} \cdot X ⌋ \qquad ( 1 )$$

wherei CWS_{rel,index} denotes the target index value, CBR_{Inters} denotes the second metric, and X denotes the number of candidates sizes in the set of candidate sizes. The operator “.” denotes the operation of multiplication, while the operator “ [symbol] ” denotes the operation of rounding down.

In such cases, the device 110 may determine a target index value from the plurality of index values based on the second metric and the number of candidate sizes in the set of candidate sizes. For example, the target index value can be determined by rounding down the product of the second metric and the number of candidate sizes. The device 110 may select, from the set of candidate sizes, a candidate size with the target index value as the target size of the CW.

Taking the CAPC equal to 3 as an example, if the second metric is equal to 0.5, then the target index value can be determined by rounding down (0.5× 7) which is equal to 3. The target size of the CW will be selected as 127 accordingly. An actual size of the CW used by the device 110 may be equal to =floor (u*target size), where u is a uniform random variable between 0 and 1 (i.e., u˜Uni(0,1)). For example, if u=0.1, then the actual size of the CW used would be floor (0.1*127)=12 CCA slots, where a CCA slot is 9 μs. It is to be understood that the example index value, the example value of the second metric, and the example set of candidate sizes are only for the purpose of illustration without suggesting any limitations.

In such cases, the device 110 may select, from the set of candidate sizes, a candidate size with the target index value as the target size of the CW. The selecting of the target size of the CW can be derived as below:

$${CW}_{p} = {CWS}_{p , vector} ( {CWS}_{rel , index} ) \qquad ( 2 )$$

wherein CW_{Srel,index} denotes the target index value, CWS_{p,vector} denotes the set of candidate sizes associated with the CAPC equal to p, and CWₚ denotes the target size of the CW.

Taking the CAPC being equal to 4 as an example, that is, the set of candidate sizes comprises {15, 31, 63, 127, 255, 511, 1023}, then the number of candidate sizes in the set of candidate sizes is equal to 7. Assuming that the second metric is equal to 0.1 which is below the threshold, then the target index value can be calculated as CW_{Srel,index}= [0.1·7]=0. The target index value is equal to 0, the device 110 may select 15 as the target size of the CW in this example. It is to be understood that the above mentioned values of the second metric, the CAPC, the target index value and the target size are only for the purpose of illustration without suggesting any limitations.

In such examples where the first metric is below, determining the target size of the CW based on the second metric may take the inter-system activity into consideration. Since the low first metric cannot indicate whether it is due to low load or congestion level of intra-system activity of the system or due to unsuccessful LBT of the device 110, considering the inter-system activity level will determine a more appropriate target size of the CW.

In some example embodiments, if the first metric exceeds the first threshold, then the method 500 will proceed with block 530. At block 530, the device 110 may determine a portion of SCI messages with feedback of the plurality of SCI messages. For example, the device 110 may determine a total number of the plurality of SCI messages, which is denoted as N_{SCI}. The device 110 may also determine a number of SCI messages which are with HARQ feedback, which is denoted as N_{SCI,HARQ}. The device 110 may further determine the portion as N_{SCP}/N_{SCI,HARQ}.

At block 540, the device 110 may determine whether the portion is below a threshold portion. The threshold portion may be preconfigured as a value between 0 and 1. If it is determined that the portion is below the threshold portion at block 540, then the method will proceed with block 550. At block 550, the device 110 may determine the target size of the CW as a size in the set of candidate sizes equal to a size of a previous CW for the LBT. Alternatively, in some example embodiments, the device 110 may instead determine a predetermined size in the set of candidate sizes as the target size of the CW.

If at block 540, the device 110 determines that the portion exceeds the threshold portion, then the method 500 will proceed with block 560. At block 560, the device 110 may determine the target size of the CW as a minimum size in the set of candidate sizes in the set of candidate sizes. For example, the device 110 may determine the target index value to be equal to 0, and select the candidate size in the set of candidate sizes associated with the index value “0” as the target size.

Alternatively, in some example embodiments, the device 110 may instead determine a size in the set of candidate sizes less than a size of a previous CW for the listen before talk as the target size of the CW. For example, the device 110 may determine the target index value as below:

$${CWS}_{rel , index} = max ( {CWS}_{rel , index , previous} - 1 , 0 ) \qquad ( 3 )$$

wherein CW_{Srel,index} denotes the target index value, CWS_{rel,index,previous} denotes the index value of a size of a previous CW for the LBT, and max (a, b) denotes the operation of determining a maximum value of a and b.

With the size in the set of candidate sizes less than the size of the previous CW, for example determined by using (3), the device 110 may then select the candidate size in the set of candidate sizes associated with the target index value as the target size.

Alternatively, in some example embodiments, if the device 110 determines that the first metric is not below the first threshold at block 510, the device 110 may not proceed with the blocks 530-560. When the first metric exceeding the first threshold, it may determine the target size without considering the second metric, as the high intra-activity means low interference from inter-system. That is, the device 110 may acquire the channel via LBT. In such cases, the device 110 may determine the target size of the CW as one of: a minimum size in the set of candidate sizes; or a predetermined size in the set of candidate sizes; or a size in the set of candidate sizes less than or equal to a size of a previous CW for the LBT.

By determining the target size of the CW based on the at least one of the first and second metrics, or also referred to as the level of intra-system activity and/or the level of inter-system activity, it enables the device to select an appropriate size of the CW even in the situation that no HARQ feedback is available. In this way, the devices or the NR system will be able to coexist fairly with other systems in unlicensed spectrum by performing such CW adjustment. In addition, SL in unlicensed band (SL-U) performance will be enhanced.

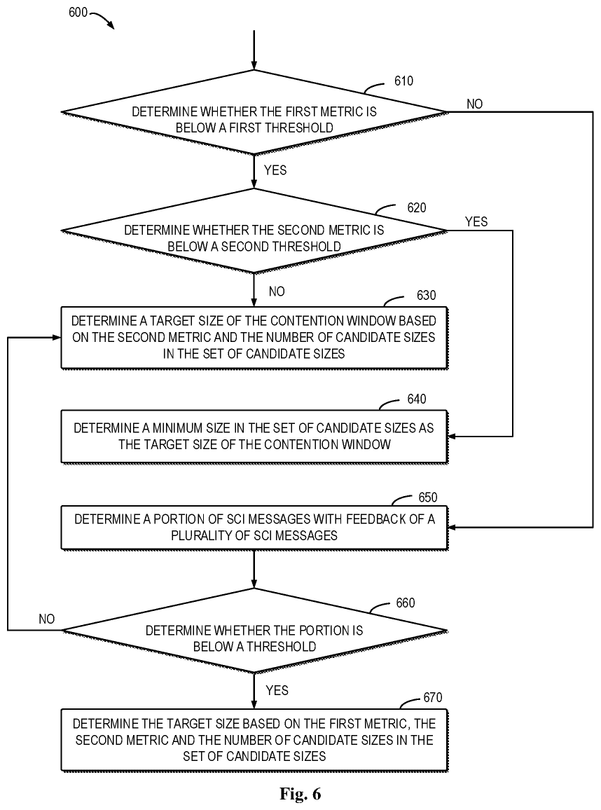

FIG. 6 illustrates another flowchart of a method 600 for selecting the size of the contention window from the candidate sizes according to some other example embodiments of the present disclosure. FIG. 6 can be regarded as another example implementation of the block 420 in FIG. 4. For the purpose of discussion, the method 600 will be described from the perspective of a device 110 in FIG. 1.

At block 610, the device 110 may determine whether the first metric is below a first threshold. For example, the first threshold may be a preconfigured level of activity. The first threshold may be preconfigured or predetermined as a value between 0 and 1. If it is determined that the first metric is below the first threshold at block 610, then the method 600 may proceed with block 620.

At block 620, the device 110 may determine whether the second metric is below a second threshold. For example, the second threshold may be a preconfigured level of activity, such as a value between 0 and 1. It is to be understood that the first threshold and the second threshold may be the same or different. If it is determined that the second metric is not below the second threshold at block 620, then the method 600 may proceed with block 630. At block 630, the device 110 may determine the target size of the CW based on the second metric and the number of candidate sizes in the set of candidate sizes. The block 630 may be the same with the block 520 in FIG. 5, which will not be repeated here.

If the device 110 determines that the second metric is below the second threshold at block 620, then the method 600 may proceed with block 640. At block 640, the device 110 may determine a minimum size in the set of candidate sizes as the target size of the CW. For example, if the CAPC is equal to 1, then the minimum size in the set of candidate sizes which is equal to 3 can be determined as the target size of the CW.

In some example embodiments, if at block 610, the device 110 determines that the first metric exceeds the first threshold, then the method 600 will proceed with block 650. At block 650, the device 110 may determine a portion of SCI messages with feedback of the plurality of SCI messages. For example, the device 110 may determine a total number of the plurality of SCI messages, which is denoted as N_{SCI}. The device 110 may also determine a number of SCI messages which are with HARQ feedback, which is denoted as N_{SCI,HARQ}. The device 110 may further determine the portion as N_{SCP}/N_{SCI,HARQ}.

At block 660, the device 110 may determine whether the portion is below a threshold portion. The threshold portion may be preconfigured as a value between 0 and 1. If at block 660, the device 110 determines that the portion exceeds the threshold portion, then the method 600 will proceed with block 630. The portion exceeding the threshold portion usually indicates that the SL transmissions are dominated by HARQ transmissions and therefore most transmissions can adapt their sizes of CW to the level of congestion and therefore only inter-system congestion needs to be accounted for. Therefore, the target size of the CW determined based on the second metric can be appropriate to avoid congestions.

If it is determined that the portion is below the threshold portion at block 660, then the method will proceed with block 670. At block 670, the device 110 may determine the target size based on the first metric, the second metric, and the number of candidate sizes in the set of candidate sizes. The portion below the threshold portion usually indicates that the SL transmissions are dominated by non-HARQ transmissions and therefore most transmissions cannot adapt their sizes of CW to the level of congestion and therefore most systems congestion needs to be account.

In such cases, the device 110 may determine the target index value based on the number of candidate sizes in the set of candidate sizes and a sum of the first metric and the second metric. Likewise, the device 110 may select, from the set of candidate sizes, a candidate size with the target index value as the target size of the CW. An example calculation of the target index value in such case is illustrated as below:

$${CWS}_{rel , index} = ⌊ ( {CBR}_{intraS} + {CBR}_{interS} ) \cdot X ⌋ \qquad ( 4 )$$

wherein CW_{Srel,index} denotes the target index value, CBR_{Intras} denotes the first metric, CBR_{Inters} denotes the second metric, and X denotes the number of candidates sizes in the set of candidate sizes. The operator “.” denotes the operation of multiplication, while the operator “└┘” denotes the operation of rounding down. With the calculated target index value, the target size can be determined accordingly.

Some example embodiments of determining the target size of the CW based on the at least one metric have been described above. By determining the target size of the CW based on the at least one of the first and second metrics, or also referred to as the level of intra-system activity and the level of inter-system activity, it enables the device to select an appropriate size of the CW even in the situation that no HARQ feedback is available. In this way, the devices or the NR system will be able to coexist fairly with other systems in unlicensed spectrum by performing such CW adjustment. In addition, SL in unlicensed band (SL-U) performance will be enhanced.

It is to be understood that this proposed approach for determining the target size of the CW can also be applied in the situation where the HARQ feedback is available. For example, an initial size of the CW can be determined based on at least one metric when the transmission will have HARQ feedback associated. This approach can be applied separately, or in combination with the approach based on the HARQ feedback.

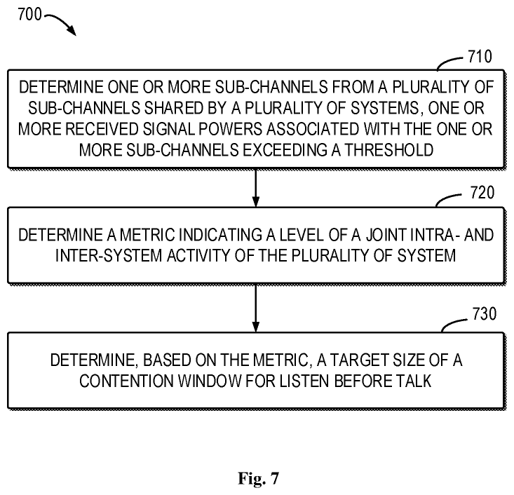

FIG. 7 shows another flowchart of an example method 700 implemented at a device in accordance with some example embodiments of the present disclosure. For the purpose of discussion, the method 700 will be described from the perspective of a device 110 in FIG. 1.

At block 710, the device 110 determines one or more sub-channels from a plurality of sub-channels shared by a plurality of systems. One or more received signal powers of a plurality of received signal powers associated with the one or more sub-channels exceed a threshold. At block 720, the device 110 determines a metric based on a portion of the one or more sub-channels of the plurality of sub-channels. This metric (also referred to as a third metric) may indicate a level of a joint intra-system and inter-system activity of the plurality of systems.

In some example embodiments, the device 110 may determine the third metric based on a plurality of RSSIs. For example, the device 110 may determine one or more sub-channels from the plurality of sub-channels. One or more RSSIs of the plurality of RSSIs associated with the one or more sub-channels exceed a threshold. The device 110 may determine the third metric based on a portion of the one or more sub-channels of the plurality of sub-channels. The third metric can also be referred to as SL CBR. The SL CBR may be defined as the portion of sub-channels in the set of resources whose SL RSSI measured by the device exceed a preconfigured threshold sensed over a CBR measurement window [n-a, n-1], wherein a is equal to 100 or 200 us slots, according to higher layer parameter sl-Time WindowSizeCBR.

At block 730, the device 110 determines, based on the third metric, a target size of a contention window for listen before talk. For example, the device 110 may select the target size based on the third metric from the set of candidate sizes described above. As discussed above, the set of candidate sizes comprise a plurality of candidate sizes with a plurality of index values ranked in an ascending order of the associated candidate sizes. For example, in Table 1, when the CAPC is equal to 3, the set of candidate sizes comprise {15, 31, 63, 127, 255, 511, 1023}. In this example, the size of “15” is associated with a rank 0, the size of “31” is associated with a rank 1 . . . and the size of “1023” is associated with a rank 6.

In such cases, the device 110 may determine a target index value from the plurality of index values based on the third metric and the number of candidate sizes in the set of candidate sizes. For example, the target index value can be determined by rounding down the product of the third metric and the number of candidate sizes. The device 110 may select, from the set of candidate sizes, a candidate size with the target index value as the target size of the CW.

Taking the CAPC equal to 3 as an example, if the third metric is equal to 0.5, then the target index value can be determined by rounding down (0.5×7) which is equal to 3. The target size of the CW will be selected as 127 accordingly. An actual size of the CW used by the device 110 may be equal to =floor (u*target size), where u is a uniform random variable between 0 and 1 (i.e., u˜Uni (0,1)). For example, if u=0.1, then the actual size of the CW used would be floor (0.1*127)=12 CCA slots, where a CCA slot is 9 μs. It is to be understood that the example index value, the example value of the third metric, and the example set of candidate sizes are only for the purpose of illustration without suggesting any limitations.

By determining the target size of the CW based on the third metric, the device may adjust the size of the contention window without receiving the HARQ feedback. In this way, the devices or the NR system will be able to coexist fairly with other systems in unlicensed spectrum by performing such CW adjustment. In addition, SL in unlicensed band (SL-U) performance will be enhanced.

Some example embodiments of determining the target size of the CW based on the at least one metric have been described above. It is to be understood that this proposed approach for determining the target size of the CW can also be applied in the situation where the HARQ feedback is available. For example, an initial size of the CW can be determined based on at least one metric when the transmission will have HARQ feedback associated. This approach can be applied separately, or in combination with the approach based on the HARQ feedback.

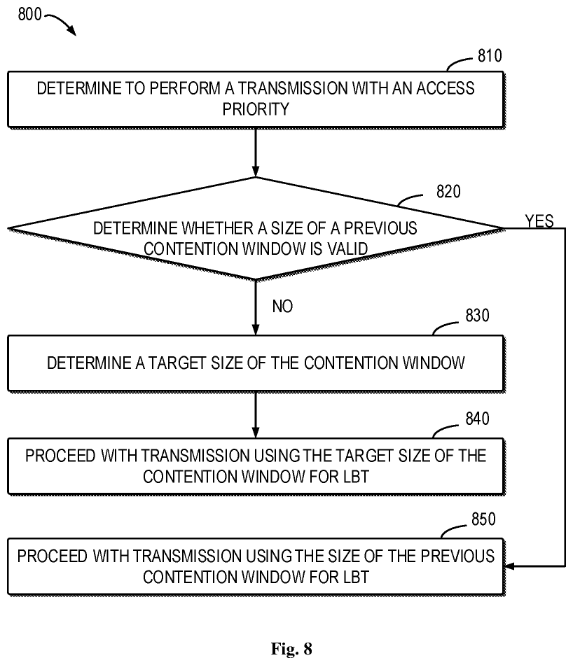

In some example embodiments, the device 110 may perform additional operations, such as determining whether to perform the above described metrics based CW adjustment. FIG. 8 illustrates a flowchart of a method 800 for determining whether to perform the metrics based CW adjustment in accordance with some example embodiments of the present disclosure. For the purpose of discussion, the method 800 will be described from the perspective of a device 110 in FIG. 1.

At block 810, the device 110 may determine to perform a transmission with an access priority. The access priority may be a channel access priority class (CAPC) associated with a traffic of the device's 110. For example, the device 110 may be indicated by its upper layer that the device 110 is required to perform a transmission with a given quality of service (QOS). The CAPC may be translated based on the given QoS. In some cases, the device 110 is not under a valid COT and therefore has to perform LBT such as LBT Type 1.

At block 820, the device 110 may determine whether a size of a previous CW is valid. The size of the previous CW can be determined by any suitable method, such as determined based on a HARQ feedback, using example methods according to the present disclosure, or using any other suitable method.

In some example embodiments, the device 110 may determine whether the size of the previous CW is valid by using one or more timers. For example, if a timer associated with a previous transmission of the device 110 is running, then the device 110 may determine that the size of the previous CW is still valid. Otherwise, the size of the previous CW is not valid. One example timer is a decreasing validity timer. This timer may be reset back to a preconfigured value every time a transmission is performed by the device 110 and therefore a CW adjustment (also referred to as a CWS adaptation) is taking place. As used herein, the term of “CW adjustment” or “CWS adjustment/adaptation) may be referred to adjusting the size of CW of the LBT. It is to be understood that an increasing timer with a time threshold may also be used.

In some example embodiments, a first timer may be set for the transmissions with HARQ feedback, and a second timer may be set for the transmissions without the HARQ feedback. The transmissions with HARQ feedback refers to those transmissions which when received by a responding device, will cause the responding device to transmit a HARQ feedback. On the other hand, the transmissions without HARQ feedback refers to those transmissions which when received by a responding device, will not lead to a HARQ feedback from the responding device. The first timer may be reset back to a first value every time a transmission with HARQ feedback is performed, while the second timer may be reset back to a second value every time a transmission without HARQ feedback is performed. The first value and the second value may be the same or different. It is to be understood that the device 100 may use one timer for all transmissions, two timers for the above two kinds of transmission, three timers for the two kinds of transmissions and the all transmissions, and even more timers. If at least one timer is still running, the device 110 may determine that the size of the previous CW is valid.

Alternatively or in addition, in some example embodiments, the device 110 may determine the validity of the size of the previous CW based on a difference between the size of the previous CW and a size of a CW previously determined based on the at least one metric. Details regarding how to determining the size of the CW based on the at least one metric have been described in details with respect to FIGS. 3-7 below. For example, if the difference between the size of the previous CW and the size of the CW previously determined based on at least one of a level of intra-system activity, a level of inter-system activity, or a joint level of intra- and inter-system activity is below a threshold difference, the device 110 may determine that the size of the previous CW is valid.

If at block 820, the device 110 determines that the size of the previous CW is valid, then the method 800 will proceed to block 850. At block 850, the device 110 may proceed with the transmission using the size of the previous CW for LBT. That is, the device 110 may perform a LBT with the size of the previous CW. If the LBT passes the LBT during a time duration corresponding to the size of the previous CW, then the device 110 may perform the transmission within a following COT. For example, the device 110 may transmit the transmission to a further device in the communication environment 100.

If at block 820, the device 110 determines that the size of the previous CW is not valid, then the method 800 will proceed to block 830. At block 830, the device 110 may determine a target size of the CW. For example, the device 110 may determine the target size based on the at least one metric or the system activity level by using any of the methods described above. At block 840, the device 110 may proceed with the transmission using the target size of the CW for LBT. That is, the device 110 may perform a LBT with the target size of the CW. If the LBT passes the LBT during a time duration corresponding to the target size of the CW, then the device 110 may perform the transmission within a following COT. For example, the device 110 may transmit the transmission to a further device in the communication environment 100.

By using the method 800 described above, the device 110 can determine when to perform a CW adjustment without receiving the HARQ feedback. In this way, even in the situation where no HARQ feedback is configured, the device 110 may also adjust the size of the CW for LBT, which will in turn reduce collisions between different systems. In this way, the SL transmission performance will be enhanced.

### Example Apparatuses

In some example embodiments, an apparatus capable of performing any of the method 300 (for example, a device 110 in FIG. 1 or the initiating device 210 in FIG. 2) may comprise means for performing the respective operations of the method 300. The means may be implemented in any suitable form. For example, the means may be implemented in a circuitry or software module. The apparatus may be implemented as or included in a device 110 in FIG. 1.

In some example embodiments, the apparatus comprises means for receiving one or more messages in a set of resources shared by a plurality of systems. The apparatus further comprises means for determining, based on the one or more messages, at least one of a first metric and a second metric. The first metric indicates a level of intra-system activity of one of the plurality of systems. The second metric indicates a level of inter-system activity of the plurality of systems. The apparatus further comprises means for determining, at least in part based on the at least one of the first and second metrics, a target size of a contention window for listen before talk.

In some example embodiments, the means for determining the target size of the contention window comprises: means for selecting the target size from a set of candidate sizes of the contention window at least in part based on the at least one of the first and second metrics.

In some example embodiments, the means for determining the set of candidate sizes further comprises: means for determining the set of candidate sizes based on an access priority of the device.

In some example embodiments, the means for selecting the target size at least in part based on the at least one of the first and second metrics comprises: means for determining whether the first metric exceeds a first threshold; and means for in accordance with a determination that the first metric exceeds the first threshold, determining the target size to be: a minimum size in the set of candidate sizes; or a predetermined size in the set of candidate sizes; or a size in the set of candidate sizes less than or equal to a size of a previous contention window for the listen before talk.

In some example embodiments, the means for selecting the target size at least in part based on the at least one of the first and second metrics further comprises: means for in accordance with a determination that the first metric is below the first threshold, selecting the target size from the set of candidate sizes at least in part based on the second metric.

In some example embodiments, the means for selecting the target size at least in part based on the second metric further comprises: means for determining, from the set of candidate sizes, the target size based on the second metric and the number of candidate sizes in the set of candidate sizes.

In some example embodiments, the means for selecting the target size at least in part based on the second metric comprises: means for in accordance with a determination that the second metric is below a second threshold, determining the target size as a minimum size in the set of candidate sizes.

In some example embodiments, the one or more messages comprise a plurality of sidelink control information messages received from a plurality of further devices in a predetermined time period, and the means for selecting the target size at least in part based on the at least one of the first and second metrics comprises: means for determining, from the plurality of sidelink control information messages, one or more sidelink control information messages containing feedback of previous transmissions from the device to the plurality of further devices; means for determining a proportion of the one or more sidelink control information messages of the plurality of sidelink control information messages; and means for selecting the target size from the set of candidate sizes at least in part based on the portion and the at least one of the first and second metrics.

In some example embodiments, in accordance with a determination that the portion exceeds a threshold proportion, the means for selecting the target size at least in part based on the portion and the at least one of the first and second metrics comprises: means for determining the target size as a minimum size in the set of candidate sizes or a size in the set of candidate sizes less than a size of a previous contention window for the listen before talk; or means for selecting, from the set of candidate sizes, the target size based on the second metric and the number of candidate sizes in the set of candidate sizes; and in accordance with a determination that the portion is below the threshold portion, the means for selecting the target size at least in part based on the portion and the at least one of the first and second metrics comprises: means for determining the target size as a size of a previous contention window or a predetermined size in the set of candidate sizes; or means for selecting, from the set of candidate sizes, the target size based on the first metric, the second metric and the number of candidate sizes in the set of candidate sizes.

In some example embodiments, the set of candidate sizes comprises a plurality of candidate sizes with a plurality of index values ranked in an ascending order of the associated candidate sizes.

In some example embodiments, the means for selecting the target size based on the second metric and the number of candidate sizes comprises: means for determining a target index value from the plurality of index values based on the second metric and the number of candidate sizes in the set of candidate sizes; and means for selecting, from the set of candidate sizes, a candidate size with the target index value as the target size.

In some example embodiments, the means for selecting the target size based on the first metric, the second metric and the number of candidate sizes in the set of candidate sizes comprises: means for determining a target index value from the plurality of index values based on the number of candidate sizes in the set of candidate sizes and a sum of the first metric and the second metric; and means for selecting, from the set of candidate sizes, a candidate size associated with the target index value as the target size.

In some example embodiments, the set of resources comprises a plurality of sub-channels, and the one or more messages contain a plurality of received signal reference powers associated with the plurality of sub-channels, and the means for determining the at least one of the first and second metrics comprises: means for determining the at least one of the first and second metrics at least in part based on the plurality of received signal reference powers.

In some example embodiments, the means for determining the at least one of the first and second metrics comprises: means for determining one or more sub-channels from the plurality of sub-channels, one or more received signal reference powers of the plurality of received signal reference powers associated with the one or more sub-channels exceeding a threshold power; and means for determining the first metric based on a portion of the one or more sub-channels of the plurality of sub-channels.

In some example embodiments, the means for determining the at least one of the first and second metrics comprises: means for detecting a plurality of received signal powers associated with the plurality of sub-channels; means for determining one or more sub-channels from the plurality of sub-channels, a difference between one or more received signal reference powers of the plurality of received signal reference powers and one or more received signal powers of the plurality of received signal powers associated with the one or more sub-channels exceeding a threshold difference; and means for determining the second metric based on a portion of the one or more sub-channels of the plurality of sub-channels.

In some example embodiments, the apparatus further comprises means for determining whether a size of a previous contention window is valid; and in accordance with a determination that the size of the previous contention window is valid, performing the listen before talk using the size of the previous contention window without determining the target size of contention window.

In some example embodiments, the means for determining whether the size of the previous contention window is valid comprises: means for determining that the size of the previous contention window is valid if: a timer associated with a previous transmission of the device is running; and/or a difference between the size of the previous contention window and a size of a contention window previously determined based on the level of intra-system activity and the level of inter-system activity is below a threshold difference.

In some example embodiments, an apparatus capable of performing any of the method 700 (for example, a device 110 in FIG. 1) may comprise means for performing the respective operations of the method 700. The means may be implemented in any suitable form. For example, the means may be implemented in a circuitry or software module. The apparatus may be implemented as or included in a device 110 in FIG. 1.

In some example embodiments, the apparatus comprises means for determining one or more sub-channels from a plurality of sub-channels shared by a plurality of systems, one or more received signal powers of a plurality of received signal powers associated with the one or more sub-channels exceeding a threshold. The apparatus further comprises means for determining, based on a portion of the one or more sub-channels of the plurality of sub-channels, a third metric indicating a level of a joint intra- and inter-system activity of the plurality of systems. The apparatus further comprises means for determining, based on the third metric, a target size of a contention window for listen before talk.

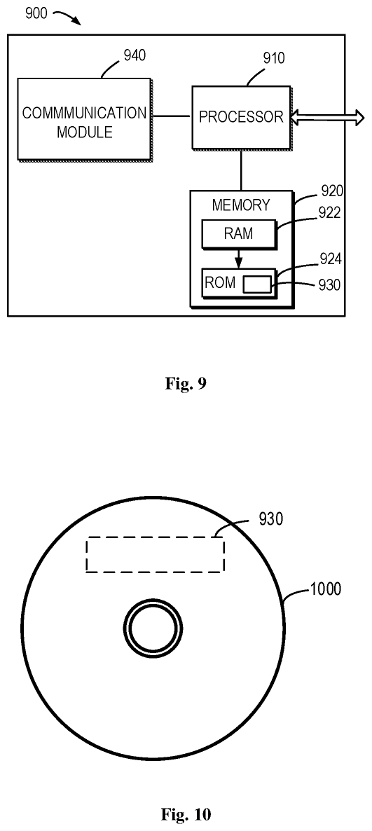

FIG. 9 is a simplified block diagram of a device 900 that is suitable for implementing example embodiments of the present disclosure. The device 900 may be provided to implement a communication device, for example, the device 110 as shown in FIG. 1, or an initiating device 210 or a responding device 220 as shown in FIG. 2. As shown, the device 900 includes one or more processors 910, one or more memories 920 coupled to the processor 910, and one or more communication modules 940 coupled to the processor 910.

The communication module 940 is for bidirectional communications. The communication module 940 has one or more communication interfaces to facilitate communication with one or more other modules or devices. The communication interfaces may represent any interface that is necessary for communication with other network elements. In some example embodiments, the communication module 940 may include at least one antenna.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The program 930 may be stored in the memory, e.g., ROM 924. The processor 910 may perform any suitable actions and processing by loading the program 930 into the RAM 922.

The example embodiments of the present disclosure may be implemented by means of the program 930 so that the device 900 may perform any process of the disclosure as discussed with reference to FIGS. 3 to 8. The example embodiments of the present disclosure may also be implemented by hardware or by a combination of software and hardware.

In some example embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. The computer readable medium may include any types of tangible non-volatile storage, such as ROM, EPROM, a flash memory, a hard disk, CD, DVD, and the like. FIG. 10 shows an example of the computer readable medium 1000 which may be in form of CD. DVD or other optical storage disk. The computer readable medium has the program 930 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target physical or virtual processor, to carry out any of the methods as described above with reference to FIGS. 3-8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-38. (canceled)

39. A device, comprising:
at least one processor; and
at least one memory including computer program code;
the at least one memory and the computer program code configured to, with the at least one processor, cause the apparatus at least to:
receive one or more messages in a set of resources shared by a plurality of systems;
determine, based on the one or more messages, at least one of a first metric and a second metric, the first metric indicating a level of intra-system activity of one of the plurality of systems, and the second metric indicating a level of inter-system activity of the plurality of systems; and
determine, at least in part based on the at least one of the first and second metrics, a target size of a contention window for listen before talk.

40. The device of claim 39, wherein the device is caused to determine the target size of the contention window by:
selecting the target size from a set of candidate sizes of the contention window at least in part based on the at least one of the first and second metrics.

41. The device of claim 40, wherein the device is further caused to determine the set of candidate sizes by:
determining the set of candidate sizes based on an access priority of the device.

42. The device of claim 40, wherein the device is caused to select the target size at least in part based on the at least one of the first and second metrics by:
determining whether the first metric exceeds a first threshold; and
in accordance with a determination that the first metric exceeds the first threshold, determining the target size to be:
a minimum size in the set of candidate sizes; or
a predetermined size in the set of candidate sizes; or
a size in the set of candidate sizes less than or equal to a size of a previous contention window for the listen before talk.

43. The device of claim 40, wherein the device is caused to select the target size at least in part based on the at least one of the first and second metrics by:
in accordance with a determination that the first metric is below the first threshold, selecting the target size from the set of candidate sizes at least in part based on the second metric.

44. The device of claim 43, wherein the device is caused to select the target size at least in part based on the second metric by:
determining, from the set of candidate sizes, the target size based on the second metric and the number of candidate sizes in the set of candidate sizes.

45. The device of claim 43, wherein the device is caused to select the target size at least in part based on the second metric by:
in accordance with a determination that the second metric is below a second threshold, determining the target size as a minimum size in the set of candidate sizes.

46. The device of claim 40, wherein the one or more messages comprise a plurality of sidelink control information messages received from a plurality of further devices in a predetermined time period, and the device is further caused to select the target size at least in part based on the at least one of the first and second metrics by:
determining, from the plurality of sidelink control information messages, one or more sidelink control information messages containing feedback of previous transmissions from the device to the plurality of further devices;
determining a proportion of the one or more sidelink control information messages of the plurality of sidelink control information messages; and
selecting the target size from the set of candidate sizes at least in part based on the portion and the at least one of the first and second metrics.

47. The device of claim 46, wherein the device is caused to select the target size at least in part based on the portion and the at least one of the first and second metrics by:
in accordance with a determination that the portion exceeds a threshold proportion,
determining the target size as a minimum size in the set of candidate sizes or a size in the set of candidate sizes less than a size of a previous contention window for the listen before talk; or
selecting, from the set of candidate sizes, the target size based on the second metric and the number of candidate sizes in the set of candidate sizes; and
in accordance with a determination that the portion is below the threshold portion,
determining the target size as a size of a previous contention window or a predetermined size in the set of candidate sizes; or
selecting, from the set of candidate sizes, the target size based on the first metric, the second metric and the number of candidate sizes in the set of candidate sizes.

48. The device of claim 47, wherein the set of candidate sizes comprises a plurality of candidate sizes with a plurality of index values ranked in an ascending order of the associated candidate sizes.

49. The device of claim 48, wherein the device is caused to select the target size based on the second metric and the number of candidate sizes by:
determining a target index value from the plurality of index values based on the second metric and the number of candidate sizes in the set of candidate sizes; and
selecting, from the set of candidate sizes, a candidate size with the target index value as the target size.

50. The device of claim 47, wherein the device is caused to select the target size based on the first metric, the second metric and the number of candidate sizes in the set of candidate sizes by:
determining a target index value from the plurality of index values based on the number of candidate sizes in the set of candidate sizes and a sum of the first metric and the second metric; and
selecting, from the set of candidate sizes, a candidate size associated with the target index value as the target size.

51. The device of claim 39, wherein the set of resources comprises a plurality of sub-channels, and the one or more messages contain a plurality of received signal reference powers associated with the plurality of sub-channels, and the device is caused to determine the at least one of the first and second metrics by:
determining the at least one of the first and second metrics at least in part based on the plurality of received signal reference powers.

52. The device of claim 51, wherein the device is caused to determine the at least one of the first and second metrics by:
determining one or more sub-channels from the plurality of sub-channels, one or more received signal reference powers of the plurality of received signal reference powers associated with the one or more sub-channels exceeding a threshold power; and
determining the first metric based on a portion of the one or more sub-channels of the plurality of sub-channels.

53. The device of claim 51, wherein the device is caused to determine the at least one of the first and second metrics by:
detecting a plurality of received signal powers associated with the plurality of sub-channels;
determining one or more sub-channels from the plurality of sub-channels, a difference between one or more received signal reference powers of the plurality of received signal reference powers and one or more received signal powers of the plurality of received signal powers associated with the one or more sub-channels exceeding a threshold difference; and
determining the second metric based on a portion of the one or more sub-channels of the plurality of sub-channels.

54. The device of claim 39, wherein the device is further caused to:
determine whether a size of a previous contention window is valid; and
in accordance with a determination that the size of the previous contention window is valid, perform the listen before talk using the size of the previous contention window without determining the target size of contention window.

55. The device of claim 54, wherein the device is caused to determine whether the size of the previous contention window is valid by:
determining that the size of the previous contention window is valid if:
a timer associated with a previous transmission of the device is running; and/or
a difference between the size of the previous contention window and a size of a contention window previously determined based on the level of intra-system activity and the level of inter-system activity is below a threshold difference.

56. A device comprising:
at least one processor; and
at least one memory including computer program code;
wherein the at least one memory and the computer program code are configured to, with the at least one processor, cause the device to:
determine one or more sub-channels from a plurality of sub-channels shared by a plurality of systems, one or more received signal powers of a plurality of received signal powers associated with the one or more sub-channels exceeding a threshold;
determine, based on a portion of the one or more sub-channels of the plurality of sub-channels, a third metric indicating a level of a joint intra- and inter-system activity of the plurality of systems; and
determine, based on the third metric, a target size of a contention window for listen before talk.

57. A method comprising:
receiving, by a device, one or more messages in a set of resources shared by a plurality of systems;
determining, based on the one or more messages, at least one of a first metric and a second metric, the first metric indicating a level of intra-system activity of one of the plurality of systems, and the second metric indicating a level of inter-system activity of the plurality of systems; and
determining, at least in part based on the at least one of the first and second metrics, a target size of a contention window for listen before talk.

58. The method of claim 57, wherein determining the target size of the contention window comprises:
selecting the target size from a set of candidate sizes of the contention window at least in part based on the at least one of the first and second metrics.
